(19) United States
(12) Patent Application Publication
(10) Pub. No.: US 2025/0239841 A1
(43) Pub. Date: Jul. 24, 2025

(54) ROUTING MEMBER AND WIRE HARNESS

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventor: Mamoru NAGAI, Yokkaichi-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 18/703,545

(22) PCT Filed: Oct. 20, 2022
(86) PCT No.: PCT/JP2022/039067

§ 371 Date: Apr. 22, 2024

(30) Foreign Application Priority Data
Nov. 8, 2021 (JP) 2021-182013

(51) Int. Cl. H02G 3/04; H01B 7/00

(52) U.S. Cl. CPC H02G 3/0487; H01B 7/0045

(57) ABSTRACT

A routing member including: a first housing that includes a first tube through which a first wire passes; and a second housing that includes a second tube that differs from the first tube, and through which a second wire, which differs from the first wire, passes, wherein: the first housing further includes at least one first joint provided integrally with the first tube, the second housing further includes at least one second joint provided integrally with the second tube, and the at least one second joint is joined to the at least one first joint and together with the at least one first joint maintains a state where the second tube is disposed along the first tube.

### BACKGROUND

The present disclosure relates to a routing member and a wire harness.

A wire harness is conventionally used in a vehicle, such as a hybrid vehicle or an electric vehicle, to electrically connect electric devices that are supplied with power from a high-voltage battery (see, for example, JP 2004-171952A). A wire harness includes at least one wire that electrically connects such electric devices together.

### SUMMARY

In addition to a high-voltage battery, a vehicle, such as a hybrid vehicle or an electric vehicle, will include a low-voltage battery capable of supplying a lower voltage than the high-voltage battery. The high-voltage battery is typically disposed at a position toward the rear of the vehicle. The plurality of electric devices that receive power from this high voltage battery include devices disposed at positions toward the rear of the vehicle and devices disposed at positions toward the front of the vehicle. An electric device disposed at a position toward the rear of the vehicle and an electric device disposed at a position toward the front of the vehicle are electrically connected by electric wires routed so as to pass under the floor of the vehicle, for example.

Power from the low-voltage battery is typically supplied to the electric devices to which power is distributed via electrical junction boxes, such as a fuse box, junction boxes, and relay boxes. Although such electric junction boxes are often placed toward the front of the vehicle, there are both configurations where the low-voltage battery is placed toward the rear of the vehicle and configurations with the low-voltage battery toward the front of the vehicle.

When the low-voltage battery is disposed toward the rear of the vehicle, the wires that electrically connect the low-voltage battery and the electrical junction box may be routed so as to pass through the interior of the vehicle. However, when routing wires so as to pass through the interior of a vehicle, there can be problems due to electromagnetic noise and difficulty in routing due to limited availability of space for wiring. For this reason, it is desirable to route wires that electrically connect the low-voltage battery and electric junction boxes so as to pass under the floor of the vehicle along the wires that electrically connect the electric devices that receive power from the high-voltage battery.

An exemplary aspect of the disclosure provides a routing member and a wire harness that facilitate routing of wires used to supply power from a low-voltage battery along wires used to supply power from a high voltage battery.

A routing member according to an aspect of the present disclosure includes: a first housing that includes a first tube through which a first wire passes; and a second housing that includes a second tube that differs from the first tube, and through which a second wire, which differs from the first wire, passes, wherein: the first housing further includes at least one first joint provided integrally with the first tube, the second housing further includes at least one second joint provided integrally with the second tube, and the at least one second joint is joined to the at least one first joint and together with the at least one first joint maintains a state where the second tube is disposed along the first tube.

A wire harness according to an aspect of the present disclosure includes: the routing member described above; at least one first wire that passes through the first tube; and at least one second wire that passes through the second tube.

According to the routing member and wire harness according to the present disclosure, it is possible to easily route wires used to supply power from a low-voltage battery along wires used to supply power from a high-voltage battery.

### BRIEF DESCRIPTION OF THE DRAWINGS

FIG. 1 is a schematic diagram depicting a wire harness according to a first embodiment.

FIG. 2 is a plan view schematically depicting part of the wire harness according to the first embodiment.

FIG. 3 is a horizontal section schematically depicting the wire harness according to the first embodiment.

FIG. 4 is a plan view schematically depicting part of a wire harness according to a second embodiment.

FIG. 5 is a horizontal section schematically depicting the wire harness according to a second embodiment.

FIG. 6 is a horizontal section schematically depicting a wire harness according to a modification.

FIG. 7 is a plan view schematically depicting part of a wire harness according to a modification.

FIG. 8 is a horizontal section schematically depicting the wire harness according to the modification depicted in FIG. 7.

### DETAILED DESCRIPTION OF EMBODIMENTS

### Description of Embodiments of the Disclosure

Configurations included in the embodiments of the present disclosure are described below in brief.

(1) A routing member according to an aspect of the present disclosure is a routing member including: a first housing member including a first tubular member through which a first wire passes; and a second housing member including a second tubular member that differs from the first tubular member and through which a second wire, which differs from the first wire, passes, wherein the first housing member further includes at least one first joining portion provided integrally with the first tubular member, the second housing member further includes at least one second joining portion provided integrally with the second tubular member, and the at least one second joining portion is joined to the at least one first joining portion and together with the at least one first joining portion maintains a state where the second tubular member is disposed along the first tubular member.

According to the above configuration, by joining the first joining portions and the second joining portions, it is possible to easily dispose the second tubular member along the first tubular member. Accordingly, it is possible to easily route the second wire that passes through the second tubular member along the first wire that passes through the first tubular member. As one example, it is possible to easily route wires (as one example, second wires) used to supply power from a low-voltage battery along wires (as one example, first wires) used to supply power from a high-voltage battery.

Note that in situations where it is not necessary to route second wires along the first wires, so long as the second joining portions are not already joined to the first joining portions, it will also be possible to use only the first housing member out of the first housing member and the second housing member. That is, it is possible to select whether the second housing member is used. This means that it is possible to selectively use the wiring members in two situations, that is, a situation where second wires are routed along the first wires and a situation where routing is performed for only essential wires (as one example, the first wires).

(2) The first tubular member and the second tubular member are preferably both sufficiently rigid to maintain the respective shapes thereof.

According to this configuration, the first housing member and the second housing member are easy to handle, which in turn makes the routing member easier to handle. In addition, the respective strengths of the first tubular member and the second tubular member can be increased compared to a case where the members are insufficiently rigid to retain their own shapes. Accordingly, the first tubular member and the second tubular member can easily protect the first wire and the second wire from foreign matter that contacts a wire harness equipped with this routing member.

(3) The first tubular member preferably has an external form in a horizontal section that is rectangular with a shorter height than a width, the second tubular member preferably has an external form in a horizontal section that is rectangular with a shorter height than a width or rectangular with an equal width and height, and the first tubular member and the second tubular member are preferably disposed side by side in the width direction of the first tubular member and so that a height direction of the first tubular member and a height direction of the second tubular member are parallel.

According to the above configuration, it is possible to suppress an increase in size of the routing member in the height direction of the first tubular member.

(4) The second tubular member described above preferably falls within a range of a height of the first tubular member along a height direction of the first tubular member.

According to this configuration, compared to a case where the second tubular member includes a part disposed outside the height range of the first tubular member in the height direction of the first tubular member, the routing member can be made thinner in the height direction of the first tubular member.

(5) An internal space of the first tubular member preferably has a width that enables a plurality of the first wires to be disposed side by side along a width direction of the first tubular member.

According to this configuration, when there are a plurality of first wires that pass through the first tubular member, it is possible to suppress an increase in the height of the first tubular member compared to when a plurality of first wires are disposed so as to overlap in the height direction of the first tubular member. Accordingly, it is possible to contribute to a reduction in thickness of the first tubular member in the height direction.

(6) It is preferable for the first joining portions and the second joining portions to fall within a range of a height of the first tubular member and to also fall within a range of a height of the second tubular member along a height direction of the first tubular member.

According to this configuration, it is possible to suppress an increase in the size of the routing member in the height direction of the first tubular member.

(7) The first tubular member preferably includes a first side wall at one end of the first tubular member in a width direction of the first tubular member, the second tubular member preferably includes a second side wall that faces the first side wall, and each of the first joining portion and the second joining portion is preferably positioned between the first side wall and the second side wall in the width direction of the first tubular member.

According to this configuration, it is possible to prevent the shape of at least one of the first joining portions and the second joining portions from becoming complex and at least one of the first joining portions and the second joining portions from increasing in size.

(8) The first tubular member preferably includes a first side wall at one end of the first tubular member in a width direction of the first tubular member, the second tubular member preferably includes a second side wall that faces the first side wall, and a fastener that joins the first joining portion and the second joining portion is preferably located at an intermediate part of the first side wall in a height direction of the first tubular member and is located at an intermediate part of the second side wall in the height direction of the second tubular member.

According to this configuration, it is possible to suppress relative rotation of the first tubular member and the second tubular member about the fasteners. This means that vibration of at least one of the first tubular member and the second tubular member can be suppressed.

(9) The first joining portions preferably protrude from the first side wall toward the second side wall, the second joining portions preferably protrude from the second side wall toward the first side wall, and the first joining portions and the second joining portions are preferably superposed in the height direction of the first tubular member.

According to this configuration, when joining the first joining portions and the second joining portions, it is sufficient to join the first joining portions and the second joining portions that have been superposed in the height direction of the first tubular member. This facilitates the task of joining the first joining portions and the second joining portions.

(10) Each first joining portion preferably includes a first bolt hole that passes through in a height direction of the first tubular member, each second joining portion preferably includes a second bolt hole that passes through in a height direction of the second tubular member, and each first bolt hole and the second bolt hole of a second joining portion that has been superposed on a first joining portion including the first bolt hole are preferably aligned in a height direction of the first tubular member.

According to this configuration, by using the bolts, which pass through the first bolt holes and the second bolt holes, and the nuts, which fit onto the bolts, the task of joining the first joining portions and the second joining portions is facilitated.

(11) The first tubular member preferably includes a first side wall at one end of the first tubular member in the width direction of the first tubular member, and the second tubular member preferably includes a second side wall that faces the first side wall and makes surface contact with the first side wall.

According to this configuration, when the first wire that passes through the first tubular member generates heat due to the passing of current, the heat of the first wire is transferred to the first tubular member and then transferred from the first side wall to the second tubular member. Accordingly, since the heat of the first wire can also be radiated from the second tubular member, the ability of the routing member to radiate heat can be improved.

(12) The first tubular member preferably includes a first joining side wall at one end of the first tubular member in the height direction of the first tubular member, the second tubular member preferably includes a second joining side wall at one end of the second tubular member in the height direction of the second tubular member, the at least one first joining portion is preferably provided integrally with the first joining side wall, the at least one second joining portion is preferably provided integrally with the second joining side wall, and the at least one first joining portion and the at least one second joining portion are preferably superposed in the width direction of the first tubular member or in the length direction of the first tubular member.

According to this configuration, when joining the first joining portions and the second joining portions, it is sufficient to join the first joining portions and the second joining portions that have been superposed in the width direction of the first tubular member or the length direction of the first tubular member. Accordingly, the first joining portions and the second joining portions can be easily joined.

(13) Each first joining portion preferably has a first bolt hole that passes through the first joining portion in a direction in which the first joining portion and the second joining portion overlap, each second joining portion preferably has a second bolt hole that passes through the second joining portion in a direction in which the first joining portion and the second joining portion overlap, and each first bolt hole and the second bolt hole of a second joining portion superposed on a first joining portion including the first bolt hole are preferably aligned in a direction in which the first joining portion and the second joining portion overlap.

According to this configuration, by using the bolts that pass through the first bolt holes and the second bolt holes and the nuts that are fitted onto the bolts, the first joining portions and the second joining portions can be joined more easily.

(14) A wire harness according to an aspect of the present disclosure includes: the routing member described above; at least one first wire that passes through the first tubular member; and at least one second wire that passes through the second tubular member.

According to the above configuration, it is possible to achieve the same effects as the routing member described above.

### Detailed Description of Embodiments of the Present Disclosure

Specific examples of a routing member and a wire harness according to the present disclosure will be described below with reference to the drawings. For ease of explanation, parts of the configuration may be exaggerated or simplified in the drawings. The expression “parallel” in this specification includes not only configurations that are strictly parallel but also configurations that are substantially parallel within a range where the effects of the present embodiments are achieved. Likewise, the expression “perpendicular” in the present specification includes not only configurations that are strictly perpendicular but also configurations that are substantially perpendicular within a range where the effects of the present embodiments are achieved. The expression “vertical” in the present specification includes not only configurations that are strictly vertical but also configurations that are substantially vertical within a range where the effects of the present embodiments are achieved. The ratios of the dimensions of the respective components in the drawings may differ from actual products, and such ratios may differ between individual drawings. Note that the present disclosure is not limited to the illustrated examples, and is indicated by the scope of the patent claims and intended to include all modifications within the meaning and scope of the patent claims and their equivalents.

### First Embodiment

A routing member and a wire harness according to a first embodiment will be described below.

### Configuration of Wire Harness 10

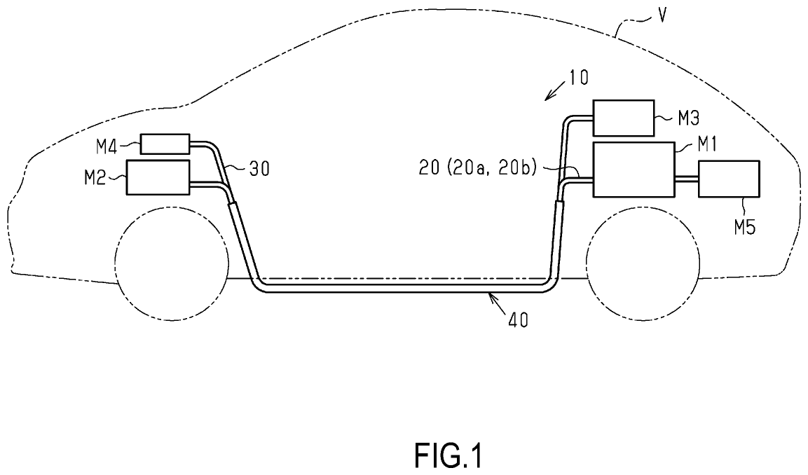

As depicted in FIG. 1, a wire harness 10 is installed in a vehicle V, such as a hybrid vehicle or an electric vehicle. The wire harness 10 electrically connects two or more electric devices M1, M2, M3, and M4. The wire harness 10 is routed so that one part of the wire harness 10 in the length direction for example passes under the floor of the vehicle V.

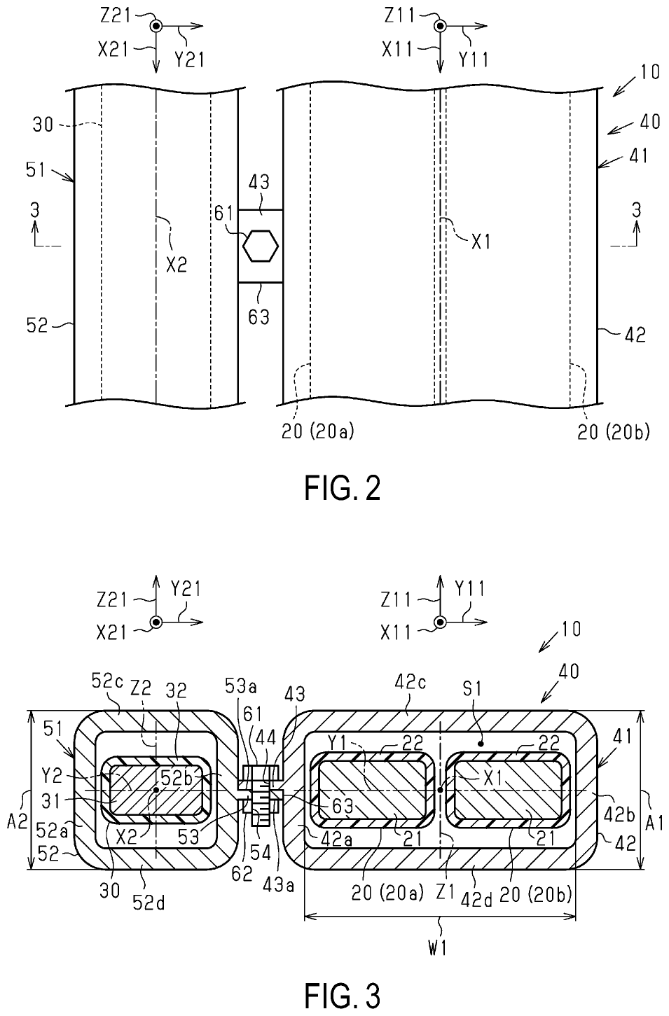

As depicted in FIG. 2, the wire harness 10 includes at least one first wire 20, at least one second wire 30 that differs from the first wire 20, and a routing member 40. As one example, the wire harness 10 includes two first wires 20, a first wire 20a and a first wire 20b. The wire harness 10 is also equipped with one second wire 30, for example.

### Configuration of First Wire 20

As depicted in FIG. 3, each of the first wire 20a and the first wire 20b includes a core wire 21 that is electrically conductive and an insulating covering 22 that covers the outer circumference of the core wire 21. Note that FIG. 3 is a cross-sectional view taken along the line 3-3 in FIG. 2.

As examples of the core wire 21, a stranded wire formed by twisting a plurality of metal wires, a column-shaped conductor formed of a single column-shaped metal rod that is internally solid, and a tubular conductor whose internal structure is hollow can be used. As another example, a combination of at least two of a stranded wire, a column-shaped conductor, and a tubular conductor may be used as the core wire 21. A metal material, such as a copper-based material or an aluminum-based material, can be used as an example material of the core wire 21.

For each of the first wires 20a and 20b, as one example, the insulating covering 22 is tube shaped and covers the entire outer circumference of the core wire 21. As one example, the insulating covering 22 is composed of a resin material that is electrically insulating.

The external form of each of the first wires 20a and 20b in a horizontal section is a flattened rectangle whose height is shorter than its width, for example. As one example, the respective external forms of the first wire 20a and the first wire 20b in a horizontal section are the same shape and the same size. Note that the external form of each of the first wires 20a and 20b in a horizontal section may be quadrangular without being a rectangular shape whose height is shorter than its width, a polygonal shape aside from a quadrangle, a circular shape, an elliptical shape, a rounded rectangular shape, or any other freely selected shape.

The first wire 20a and the first wire 20b may be the same type of wire or may be different types of wire. As one example, the first wire 20a and the first wire 20b are the same type of wire. As examples, the first wires 20a and 20b may both be a shielded wire with its own electromagnetic shielding structure, or may be a non-shielded wire without an electromagnetic shielding structure. As one example, each of the first wires 20a and 20b is a non-shielded wire.

As depicted in FIG. 1, one end of each of the first wires 20a and 20b is connected to the electric device M1 and the other end of each of the first wires 20a and 20b is connected to the electric device M2. As one example, the electric device M1 is an inverter provided toward the rear of the vehicle V. The electric device M1 is disposed in the vicinity of the trunk room of the vehicle V, for example. As one example, the electric device M2 is a motor provided closer to the front of the vehicle V than the electric device M1. This motor is a motor for driving the wheels and is a power source that enables the vehicle to move. The electric device M2 is disposed in the engine room of the vehicle V, for example. Note that an electric device M5 is disposed toward the rear side of the vehicle V, in in the vicinity of the electric device M1 for example. The electric device M5 is disposed near the trunk room of the vehicle V, for example. As one example, the electric device M5 is a high-voltage battery capable of supplying a voltage of 100 volts or higher. The electric device M1 is electrically connected to the electric device M5.

### Configuration of Second Wire 30

As depicted in FIG. 3, the second wire 30 includes a core wire 31 that is electrically conductive and an insulating covering 32 that covers the outer circumference of the core wire 21.

As examples of the core wire 31, a stranded wire formed by twisting a plurality of metal wires, a column-shaped conductor formed of a single column-shaped metal rod that is internally solid, and a tubular conductor whose internal structure is hollow can be used. As another example, a combination of at least two of a stranded wire, a column-shaped conductor, and a tubular conductor may be used as the core wire 31. A metal material, such as a copper-based material or an aluminum-based material, can be used as an example material of the core wire 31.

The insulating covering 32 is tube-shaped for example and covers the entire outer circumference of the core wire 31. As one example, the insulating covering 32 is made of a resin material that is electrically insulating.

The external form of each second wire 30 in a horizontal section is a flattened rectangle whose height is shorter than its width, for example. Note that the external form of each second wire 30 in a horizontal section may be quadrangular without being a rectangular shape whose height is shorter than its width, a polygonal shape aside from a quadrangle, a circular shape, an elliptical shape, a rounded rectangular shape, or any other freely selected shape. The second wire 30 may be thinner than both the first wires 20a and 20b, for example. That is, the external form of the second wire 30 in a horizontal section may be smaller than the respective external forms of the first wires 20a and 20b, for example.

As one example, the second wire 30 may be a shielded wire with its own electromagnetic shielding structure, or may be a non-shielded wire without an electromagnetic shielding structure. As one example, the second wire 30 is a non-shielded wire.

As depicted in FIG. 1, one end of the second wire 30 is connected to the electric device M3 and the other end of the second wire 30 is connected to the electric device M4. As one example, the electric device M3 is a low-voltage battery provided toward the rear of the vehicle V. The low-voltage battery is a battery capable of supplying a lower voltage (as one example, a voltage of 12 volts) than the high voltage battery. The electric device M3 is disposed in the vicinity of the trunk room of the vehicle V, for example. As one example, the electric device M4 is an electric junction box provided closer to the front of the vehicle V than the electric device M3. A relay box, a fuse box, and a junction box can be given as examples of this electric junction box. As one example, the electric device M4 is disposed in the engine room of the vehicle V.

### Configuration of Routing Member 40

As depicted in FIGS. 2 and 3, the routing member 40 includes a first housing member 41 (first housing) and a second housing member 51 (second housing).

### Configuration of First Housing Member 41

The first housing member 41 includes a first tubular member 42 (first tube) and at least one first joining portion 43 (first joint) that is provided integrally with the first tubular member 42.

The first tubular member 42 is tubular in shape. The first tubular member 42 is composed of a metal pipe, for example. As examples, either aluminum or an aluminum alloy can be used as the material of the first tubular member 42. Note that the material of the first tubular member 42 may be a metal material aside from aluminum and aluminum alloy. The first tubular member 42 may be sufficiently rigid to enable it to retain its own shape, for example.

Here, a direction along the central axis X1 of the first tubular member 42 is defined as the “length direction X11” of the first tubular member 42. In the drawings, a first axis Y1 that is perpendicular to the central axis X1 and a second axis Z1 that is perpendicular to the central axis X1 and perpendicular to the first axis Y1 are indicated. A direction along the first axis Y1 is defined as the “width direction Y11” of the first tubular member 42. Additionally, a direction along the second axis Z1 is defined as the “height direction Z11” of the first tubular member 42. The width direction Y11 is a direction that is perpendicular to the length direction X11. The height direction Z11 is perpendicular to the length direction X11 and perpendicular to the width direction Y11.

As one example, the external form of the first tubular member 42 in a horizontal section is a rectangle whose height is shorter than its width. It should be noted that the term “rectangular” used in this specification refers not only to rectangles with sharp corners but also to rectangles with rounded corners. A horizontal section of the first tubular member 42 is a cross section that is perpendicular to the central axis X1. The width of the first tubular member 42 is the length of the first tubular member 42 in the width direction Y11. The height of the first tubular member 42 is the length of the first tubular member 42 in the height direction Z11.

The first wire 20a and the first wire 20b pass through the first tubular member 42. One part of each of the first wires 20a and 20b in the length direction is housed inside the first tubular member 42. The internal space S1 of the first tubular member 42 is sufficiently wide for example to allow a plurality of first wires 20 to be disposed side by side along the width direction Y11. As one example, the internal space S1 has a width W1 that enables the first wire 20a and the first wire 20b to be disposed side by side along the width direction Y11. The first wire 20a is disposed inside the first tubular member 42 so that the height direction of the first wire 20a is aligned with the height direction Z11 of the first tubular member 42, for example. In the same way, the first wire 20b is disposed inside the first tubular member 42 so that the height direction of the first wire 20b is aligned with the height direction Z11 of the first tubular member 42, for example. For this reason, each of the first wires 20a and 20b that pass through the first tubular member 42 appears as thin in the height direction Z11 and wide in the width direction Y11 in a horizontal section of the wire harness 10.

As one example, the first tubular member 42 includes four side walls 42a, 42b, 42c, and 42d. Two side walls 42a and 42b out of the four side walls 42a to 42d are positioned at both ends of the first tubular member 42 in the width direction Y11. The remaining two side walls 42c and 42d are positioned at both ends of the first tubular member 42 in the height direction Z11. The side wall 42c joins the end of the side wall 42a in the height direction Z11 and the end of the side wall 42b in the height direction Z11. The side wall 42d joins the end of the side wall 42a in the opposite direction to the height direction Z11 and the end of the side wall 42b in the opposite direction to the height direction Z11. The first tubular member 42 includes the side wall 42a at one end of the first tubular member 42 in the width direction Y11. Note that the side wall 42a corresponds to a “first side wall” for the present disclosure. Out of the two side walls 42a and 42b at both ends of the first tubular member 42 in the width direction Y11, the side wall 42a is positioned closer to the rear in the width direction Y11 than the side wall 42b. As one example, the side wall 42a is shaped as a flat plate that is perpendicular to the width direction Y11.

As one example, the first housing member 41 includes a plurality of the first joining portions 43 that are integrally provided on the side wall 42a. In an example configuration, the first joining portions 43 are provided at a plurality of locations on the first tubular member 42 along the length direction X11 at intervals of several tens of cm (as one example, intervals of 50 to 100 cm).

Each of the first joining portions 43 protrudes from the side wall 42a along the first axis Y1 in the opposite direction to the width direction Y11. As one example, each of the first joining portions 43 is shaped as a flat plate that is perpendicular to the height direction Z11. As one example, each of the first joining portions 43 has a first mating surface 43a. The first mating surface 43a is a surface positioned toward the rear, for example, in the height direction Z11, out of both end surfaces of the first joining portion 43 in the height direction Z11. The first mating surface 43a is located at an intermediate position in the height direction Z11 on the side wall 42a. The first mating surface 43a is shaped as a flat surface that is perpendicular to the height direction Z11.

Each of the first joining portions 43 may have a first bolt hole 44 that passes through in the height direction Z11.

The first housing member 41 is routed so that at least part of the first tubular member 42 in the length direction X11 passes under the floor of the vehicle V, for example. This means that each of the first wire 20a and the first wire 20b that pass through the first tubular member 42 is routed so that parts thereof in the length direction pass under the floor of the vehicle V, for example. The first tubular member 42 is attached to the vehicle V so that the height direction Z11 is aligned with the vertical direction of the vehicle V, for example.

### Configuration of Second Housing Member 51

The second housing member 51 includes a second tubular member 52 (second tube) that differs from the first tubular member 42 and at least one second joining portion 53 (second joint) that is provided integrally with the second tubular member 52.

The second tubular member 52 is tubular in shape. The second tubular member 52 is composed of a metal pipe, for example. As examples, either aluminum or an aluminum alloy can be used as the material of the second tubular member 52. Note that the material of the second tubular member 52 may be a metal material aside from aluminum and aluminum alloy. The second tubular member 52 may be sufficiently rigid to enable it to retain its own shape, for example.

Here, a direction along the central axis X2 of the second tubular member 52 is defined as the “length direction X21” of the second tubular member 52. In the drawings, a first axis Y2 that is perpendicular to the central axis X2 and a second axis Z2 that is perpendicular to the central axis X2 and perpendicular to the first axis Y2 are indicated. A direction along the first axis Y2 is defined as the “width direction Z21” of the second tubular member 52. A direction along the second axis Z2 is defined as the “height direction Y21” of the second tubular member 52. The width direction Y21 is a direction that is perpendicular to the length direction X21. The height direction Z21 is perpendicular to the length direction X21 and perpendicular to the width direction Y21.

As examples, the external form of the second tubular member 52 in a horizontal section is a rectangle whose height is shorter than its width or a rectangle (square) whose width and height are equal. As one example, the external form of the second tubular member 52 in a horizontal section is a rectangle whose height is shorter than its width. Note that the width of the second tubular member 52 is the length of the second tubular member 52 in the width direction Y21. The height of the second tubular member 52 is the length of the second tubular member 52 in the height direction Z21. Note that the height of the second tubular member 52 is equal to the height of the first tubular member 42, for example. The width of the second tubular member 52 is narrower than the width of the first tubular member 42, for example.

The second wire 30 passes through the second tubular member 52. Part of the second wire 30 in the length direction is housed inside the second tubular member 52. The second wire 30 is disposed inside the second tubular member 52 so that the height direction of the second wire 30 is aligned with the height direction Z21 of the second tubular member 52, for example. For this reason, in a horizontal section of the wire harness 10, the second wire 30 that passes through the second tubular member 52 is thin in the height direction Z21 and wide in the width direction Y21.

As one example, the second tubular member 52 includes four side walls 52a, 52b, 52c, and 52d. Two side walls 52a and 52b out of the four side walls 52a to 52d are positioned at both ends of the second tubular member 52 in the width direction Y21. The remaining two side walls 52c and 52d are positioned at both ends of the second tubular member 52 in the height direction Z21. The side wall 52c joins the end of the side wall 52a in the height direction Z21 and the end of the side wall 52b in the height direction Z21. The side wall 52d joins the end of the side wall 52a in the opposite direction to the height direction Z21 and the end of the side wall 52b in the opposite direction to the height direction Z21. Note that the side wall 52b corresponds to a “second side wall” for the present disclosure. Out of the two side walls 52a and 52b at both ends of the second tubular member 52 in the width direction Y21, the side wall 52b is a side wall positioned at a more advanced position in the width direction Y21 than the side wall 52a. As one example, the sidewall 52b is shaped as a flat plate that is perpendicular to the width direction Y21.

As one example, the second housing member 51 includes a plurality of the second joining portions 53 that are integrally provided on the side wall 52b. In an example configuration, the second housing member 51 includes the same number of the second joining portions 53 as the first joining portions 43. The second joining portions 53 are provided at a plurality of locations on the second tubular member 52 along the length direction X21 at intervals of several tens of cm (as one example, intervals of 50 to 100 cm).

Each of the second joining portions 53 protrudes from the side wall 52b in the width direction Y21 along the first axis Y2 for example. As one example, each of the second joining portions 53 is shaped as a flat plate that is perpendicular to the height direction Z21. The second joining portions 53 each have the same thickness as the first joining portions 43, for example. As one example, each of the second joining portions 53 has a second mating surface 53a. As one example, the second mating surface 53a is a surface positioned toward the front in the height direction Z21, out of both end surfaces of the second joining portion 53 in the height direction Z21. The second mating surface 53a is located at an intermediate position in the height direction Z21 on the side wall 52b. The second mating surface 53a is shaped as a flat surface that is perpendicular to the height direction Z21.

Each of the second joining portions 53 may have a second bolt hole 54 that passes through in the height direction Z21.

The second housing member 51 is joined to the first housing member 41 by joining the second joining portions 53 to the first joining portions 43. Note that the joining of the first joining portions 43 and the second joining portions 53 may be performed before the first housing member 41 is attached to the vehicle V, or may be performed after the first housing member 41 has been attached to the vehicle V.

The first tubular member 42 and the second tubular member 52 are disposed so as to be side by side in the width direction Y11 and so that the height direction Z11 of the first tubular member 42 and the height direction Z21 of the second tubular member 52 are parallel. As one example, the second housing member 51 is disposed so that the side wall 52b of the second tubular member 52 faces the side wall 42a of the first tubular member 42. That is, the second tubular member 52 may have a side wall 52b that faces the side wall 42a. The side wall 42a and the side wall 52b face each other in the width direction Y11. For this reason, each first joining portion 43 protrudes from the side wall 42a toward the side wall 52b. Likewise, each second joining portion 53 protrudes from the side wall 52b toward the side wall 42a.

As one example, the respective first joining portions 43 and second joining portions 53 are superposed in the height direction Z11. Each second joining portion 53 is superposed on a first joining portion 43 with the second mating surface 53a in contact with the first mating surface 43a. A first bolt hole 44 and the second bolt hole 54 of a second joining portion 53 that is superposed on the first joining portion 43 including that first bolt hole 44 are aligned in the height direction Z11. That is, for a first joining portion 43 and a second joining portion 53 that have been superposed, the first joining portion 43 and the second joining portion 53 become side by side in the superposing direction in a state where the axis directions of the first bolt hole 44 and the second bolt hole 54 are the same. A bolt 61 is inserted into each first bolt hole 44 and second bolt hole 54 that are side by side in the height direction Z11. This bolt 61 and a nut 62 fitted onto the bolt 61 join each first joining portion 43 and the second joining portion 53 that have been superposed.

Each second joining portion 53 is joined to each first joining portion 43 and, together with a first joining portion 43, maintains a state where the second tubular member 52 is disposed along the first tubular member 42. The first joining portions 43 and the second joining portions 53 both have sufficient rigidity to maintain the state in which the second tubular member 52 is disposed along the first tubular member 42.

By joining the respective second joining portions 53 to the first joining portions 43, at least part of the second tubular member 52 in the length direction X21 is routed along the first tubular member 42. As one example, the second tubular member 52 is routed along the first tubular member 42 that passes under the floor of the vehicle V so that at least part of the second tubular member 52 in the length direction X21 passes under the floor of the vehicle V. At least part of the second wire 30 that passes through the second tubular member 52 in its length direction is routed along the first wires 20a and 20b. As one example, the second wire 30 is routed so that part of the second wire 30 in the length direction passes under the floor of the vehicle V. The first wire 20a, the first wire 20b, and the second wire 30 are disposed in a line along the width direction Y11, for example.

In the state where the second housing member 51 is joined to the first housing member 41, the second tubular member 52 falls within a height range A1 of the first tubular member 42 along the height direction Z11, for example. This means that an end surface of the second tubular member 52 in the height direction Z21 is positioned at the same position in the height direction Z11 as the end surface of the first tubular member 42 in the height direction Z11, or is positioned closer to the rear in the height direction Z11 than the end surface of the first tubular member 42 in the height direction Z11. In addition, the end surface of the second tubular member 52 in the opposite direction to the height direction Z21 is positioned at the same position in the height direction Z11 as the end surface of the first tubular member 42 in the opposite direction to the height direction Z11, or is positioned in a more advanced position in the height direction Z11 than the end surface of the first tubular member 42 in the opposite direction to the height direction Z11.

In the same state, as one example, each first joining portion 43 and second joining portion 53 will fall within a height range A1 of the first tubular member 42 and within the height range A2 of the second tubular member 52 along the height direction Z11. Also, in this state, as one example, the first joining portions 43 and the second joining portions 53 are each positioned between the side wall 42a and the side wall 52b in the width direction Y11. Also in this state, as one example, fasteners 63 for the first joining portions 43 and the second joining portions 53 are positioned at an intermediate part of the side wall 42a in the height direction Z11 and positioned at an intermediate part of the side wall 52b in the height direction Z21. That is, the center of the fasteners 63 in the height direction Z11 and the center of the side wall 42a in the height direction Z11 may be located at the same position in the height direction Z11. The center of the fasteners 63 in the height direction Z21 and the center of the side wall 52b in the height direction Z21 may be positioned at the same position in the height direction Z21. Note that the center of the fasteners 63 in the height direction Z11 or the height direction Z21 corresponds, for example, to the first mating surface 43a and the second mating surface 53a.

The effects of the present embodiment will now be described. (1-1) The routing member 40 includes the first housing member 41 including the first tubular member 42 through which the first wire 20 passes and the second housing member 51 including the second tubular member 52 that differs from the first tubular member 42 and through which the second wire 30 that differs from the first wire 20 passes. The first housing member 41 includes at least one first joining portion 43 that is integrally provided with the first tubular member 42. The second housing member 51 includes at least one second joining portion 53 that is integrally provided with the second tubular member 52. The second joining portions 53 are joined to the first joining portions 43 and together with the first joining portions 43 maintain a state where the second tubular member 52 is disposed along the first tubular member 42.

According to this configuration, by joining the first joining portions 43 and the second joining portions 53, it is easy to dispose the second tubular member 52 along the first tubular member 42. Accordingly, the second wire 30 that passes through the second tubular member 52 can be easily routed along the first wires 20 that pass through the first tubular member 42. As one example, the second wire 30 that is used to supply power from the low-voltage battery can be easily routed along the first wires 20 that are used to supply power from the high-voltage battery.

Note that as one example, when both the electric device M3 and the electric device M4 connected to the electric device M3 are disposed toward the front of the vehicle V, as one example, in the engine room, it is not necessary to route the second wire 30 along the first wires 20. When it is not necessary to route the second wire 30 along the first wires 20 in this manner, if the second joining portions 53 are not already joined to the first joining portions 43, it will be possible to use only the first housing member 41 out of the first housing member 41 and the second housing member 51. That is, it is possible to select whether the second housing member 51 is used. This means that it is possible to selectively use the routing member 40 between two situations, that is, a situation where the second wire 30 is routed along the first wires 20 and a situation where routing is performed for only the first wires 20 as essential wires.

(1-2) Each of the first tubular member 42 and the second tubular member 52 is sufficiently rigid to retain its own shape. This configuration makes the first housing member 41 and the second housing member 51 easy to handle, and in turn, makes the routing member 40 easier to handle. In addition, the respective strengths of the first tubular member 42 and the second tubular member 52 can be increased compared to a case where the members are insufficiently rigid to retain their own shapes. Accordingly, the first tubular member 42 and the second tubular member 52 can easily protect the first wire 20 and the second wire 30 from foreign matter that contacts the wire harness 10 equipped with the routing member 40. As one example, when the first tubular member 42 and the second tubular member 52 are routed so as to pass under the floor of the vehicle V, the first wire 20 and the second wire 30 can be protected from flying stones.

(1-3) The external form of the first tubular member 42 in a rectangular section is a rectangle whose height is lower than its width. The external form of the second tubular member 52 in a horizontal section is a rectangle whose height is lower than its width or whose width and height are equal. The first tubular member 42 and the second tubular member 52 are disposed side by side in the width direction Y11 of the first tubular member 42 so that the height direction Z11 of the first tubular member 42 and the height direction Z21 of the second tubular member 52 are parallel.

According to this configuration, it is possible to prevent the routing member 40 from becoming larger in the height direction Z11 of the first tubular member 42. Accordingly, by disposing the routing member 40 under the floor of the vehicle V so that the height direction Z11 is aligned with the vertical direction of the vehicle V, the space required to dispose the routing member 40 in the vertical direction of the vehicle V can be reduced.

(1-4) The second tubular member 52 falls within the height range A1 of the first tubular member 42 along the height direction Z11 of the first tubular member 42. According to this configuration, compared to a case where the second tubular member 52 includes a part disposed outside the height range A1 of the first tubular member 42 in the height direction Z11, the routing member 40 can be made thinner in the height direction Z11.

(1-5) The internal space S1 of the first tubular member 42 has a width W1 that enables a plurality of first wires 20 to be disposed side by side along the width direction Y11 of the first tubular member 42. According to this configuration, when there are a plurality of first wires 20 that pass through the first tubular member 42, it is possible to suppress an increase in the height of the first tubular member 42 compared to when a plurality of first wires 20 are disposed so as to overlap in the height direction Z11 of the first tubular member 42. This means that it is possible to contribute to a reduction in thickness of the routing member 40 in the height direction Z11.

(1-6) Each first joining portion 43 and second joining portion 53 falls within the height range A1 of the first tubular member 42 and also falls within the height range A2 of the second tubular member 52 along the height direction Z11 of the first tubular member 42. According to this configuration, it is possible to suppress an increase in the height direction Z11 of the routing member 40.

(1-7) The first tubular member 42 has the side wall 42a at one end of the first tubular member 42 in the width direction Y11 of the first tubular member 42. The second tubular member 52 includes the side wall 52b that faces the side wall 42a. Each first joining portion 43 and second joining portion 53 is positioned between the side wall 42a and the side wall 52b in the width direction Y11. According to this configuration, it is possible to prevent the shape of at least one of the first joining portion 43 and the second joining portion 53 from becoming complex and at least one of the first joining portion 43 and the second joining portion 53 from increasing in size.

(1-8) The first tubular member 42 includes the side wall 42a at one end of the first tubular member 42 in the width direction Y11 of the first tubular member 42. The second tubular member 52 includes the side wall 52b that faces the side wall 42a. The fasteners 63 between the first joining portions 43 and the second joining portions 53 are positioned at an intermediate part of the side wall 42a in the height direction Z11 and at an intermediate part of the side wall 52a in the height direction Z21.

According to this configuration, it is possible to suppress relative rotation of the first tubular member 42 and the second tubular member 52 about the fasteners 63. This means that vibration of at least one of the first tubular member 42 and the second tubular member 52 can be suppressed.

(1-9) The first joining portion 43 protrudes from the side wall 42a toward the side wall 52b. The second joining portion 53 protrudes from the side wall 52b toward the side wall 42a. The first joining portion 43 and the second joining portion 53 are superposed in the height direction Z11.

According to this configuration, when joining the first joining portion 43 and the second joining portion 53, it is sufficient to join the first joining portion 43 and the second joining portion 53 that have been superposed in the height direction Z11. This facilitates the task of joining the first joining portion 43 and the second joining portion 53.

(1-10) Each first joining portion 43 has a first bolt hole 44 that passes through in the height direction Z11. Each second joining portion 53 has a second bolt hole 54 that passes through in the height direction Z21. Each first bolt hole 44 and the second bolt hole 54 of the second joining portion 53 that is superposed on the first joining portion 43 that has that first bolt hole 44 are aligned in the height direction Z11.

According to this configuration, by using the bolt 61, which passes through the first bolt hole 44 and the second bolt hole 54, and the nut 62, which fits onto the bolt 61, the task of joining each first joining portion 43 and each second joining portion 53 is facilitated.

(1-11) The wire harness 10 includes the routing member 40, at least one first wire 20 that passes through the first tubular member 42, and at least one second wire 30 that passes through the second tubular member 52.

According to this configuration, by joining the first joining portion 43 and the second joining portion 53, the second wire 30 that passes through the second tubular member 52 can be easily routed along the first wires 20 that pass through the first tubular member 42. That is, the second wire 30 used for supplying power from the low-voltage battery can be easily routed along the first wires 20 used for supplying power from the high voltage battery.

### Second Embodiment

A second embodiment of a routing member and a wire harness are described below. Note that in this second embodiment, configurations that are the same as or correspond to those of the first embodiment described above have been assigned the same reference numerals and part or all of the description of such configurations is omitted.

### Configuration of Wire Harness 10A

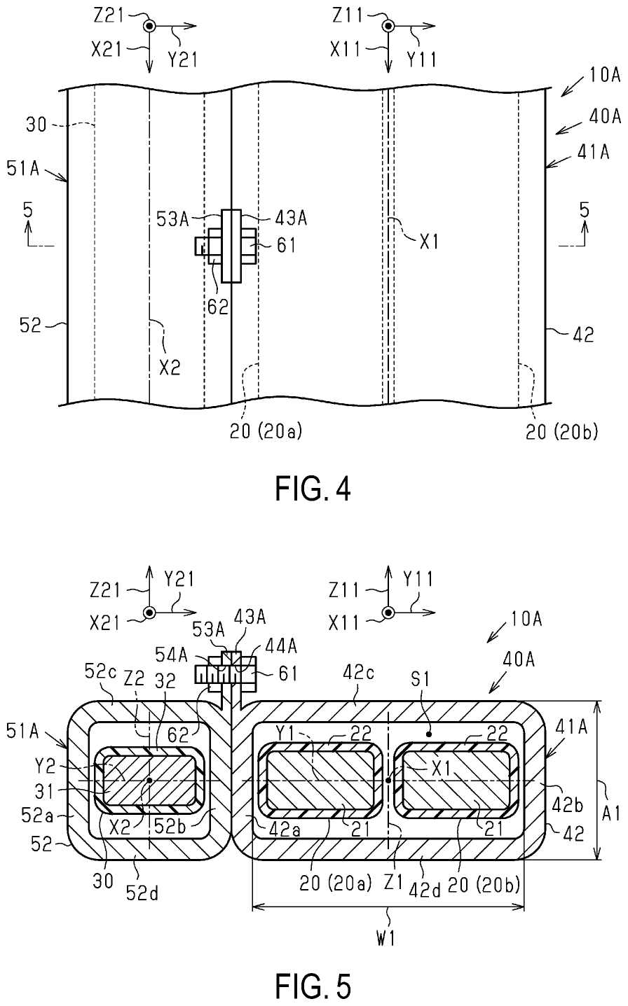

As depicted in FIGS. 4 and 5, the wire harness 10A according to the second embodiment includes a routing member 40A in place of the routing member 40 according to the first embodiment. Note that FIG. 5 is a cross-sectional view taken along the line 5-5 in FIG. 4.

### Configuration of Routing Member 40A

The routing member 40A includes a first housing member 41A and a second housing member 51A.

### Structure of First Housing Member 41A

The first housing member 41A is routed in the vehicle V in the same way as the first housing member 41 according to the first embodiment described above. The first housing member 41A includes the first tubular member 42 according to the first embodiment described above and at least one first joining portion 43A that is provided integrally on the first tubular member 42.

The first tubular member 42 includes the side wall 42c at one end of the first tubular member 42 in the height direction Z11. Note that the side wall 42c corresponds to a “first joining side wall” for the present disclosure. Out of the two side walls 42c and 42d at both ends of the first tubular member 42 in the height direction Z11, the side wall 42c is positioned in a more advanced position in the height direction Z11 than the side wall 42d. The side wall 42a corresponds to the “first side wall” for the present disclosure.

As one example, the first housing member 41A includes a plurality of first joining portions 43A. The first joining portions 43A may be provided at a plurality of locations on the first tubular member 42 along the length direction X11 at intervals of several tens of centimeters (for example, intervals of 50 to 100 cm). Each of the first joining portions 43A may be provided integrally on the side wall 42c, for example. The first joining portions 43A each protrude in the height direction Z11 from an end region of the side wall 42c in the opposite direction to the height direction Z11. As one example, each first joining portion 43A is shaped as a flat plate that is perpendicular to the width direction Y11. Each first joining portion 43A may have a first bolt hole 44A that passes through in the width direction Y11.

### Configuration of Second Housing Member 51A

The second housing member 51A includes the second tubular member 52 according to the first embodiment described above and at least one second joining portion 53A that is provided integrally on the second tubular member 52.

The second tubular member 52 includes the side wall 52c at one end of the second tubular member 52 in the height direction Z21. The side wall 52c corresponds to a “second joining side wall” for the present disclosure. Out of the two side walls 52c and 52d at both ends of the second tubular member 52 in the height direction Z21, the side wall 52c is positioned in a more advanced position in the height direction Z21 than the side wall 52d. The side wall 52b corresponds to a “second side wall” for the present disclosure.

As one example, the second housing member 51A may include a plurality of second joining portions 53A. Each second joining portion 53A is provided at a position that coincides with a first joining portion 43A in the width direction Y11. As one example, the second joining portions 53A are provided at a plurality of locations on the second tubular member 52 along the length direction X21 at intervals of several tens of centimeters (for example, intervals of 50 to 100 cm). Each of the second joining portion 53A may be provided integrally with the side wall 52c, for example. The second joining portions 53A each protrude in the height direction Z21 from an end region of the side wall 42c in the height direction Z21, for example. As one example, each second joining portion 53A is shaped as a flat plate that is perpendicular to the width direction Y21. Each second joining portion 53A may have a second bolt hole 54A that passes through in the width direction Y21.

The second housing member 51A is joined to the first housing member 41A by joining the second joining portions 53A to the first joining portions 43A. Note that the joining of the respective first joining portions 43A and second joining portions 53A may be performed before the first housing member 41A is attached to the vehicle V, or may be performed after the first housing member 41A has been attached to the vehicle V.

The first tubular member 42 and the second tubular member 52 are disposed so as to be side by side in the width direction Y11 and so that the height direction Z11 of the first tubular member 42 and the height direction Z21 of the second tubular member 52 are parallel. This means that the width direction Y21 of the second tubular member 52 and the width direction Y11 of the first tubular member 42 are the same direction. As one example, the second housing member 51 is disposed so that the side wall 52b of the second tubular member 52 faces and is in surface contact with the side wall 42a of the first tubular member 42. That is, the second tubular member 52 may have a side wall 52b that faces and makes surface contact with the side wall 42a.

The first joining portions 43A and second joining portions 53A are respectively superposed in the width direction Y11, for example. The second joining portions 53A may be superposed on the respective first joining portions 43A so as to contact the first joining portions 43. Since the first bolt holes 44A pass through the respective first joining portions 43A in the width direction Y11, each first joining portion 43A has a first bolt hole 44A that passes through the first joining portion 43A in the direction in which the first joining portion 43A and the second joining portion 53A overlap. Likewise, since the second bolt holes 54A respectively pass through the second joining portions 53A in the width direction Y21, each second joining portion 53A has a second bolt hole 54A that passes through the second joining portion 53A in the direction in which the first joining portions 43A and the second joining portions 53A overlap. Each of the first bolt holes 44A and the second bolt holes 54A of the second joining portion 53A that has been superposed on the first joining portion 43A including that first bolt hole 44A are side by side in the direction in which the first joining portion 43A and the second joining portion 53A overlap. That is, for a first joining portion 43A and a second joining portion 53A that have been superposed, the first joining portion 43A and the second joining portion 53A are disposed side by side in the direction in which the first joining portion 43A and the second joining portion 53A overlap in a state where the axis directions of the first bolt hole 44A and the second bolt hole 54A are in the same direction. As one example, each of the first bolt holes 44A and the second bolts hole 54A of the second joining portion 53A that has been superposed on the first joining portion 43A with that first bolt hole 44A are side by side in the width direction Y11. A bolt 61 is inserted into the first bolt hole 44 and the second bolt hole 54 that are aligned in the width direction Y11. The bolt 61 and the nut 62 fitted onto the bolt 61 join the first joining portion 43A and the second joining portion 53A that have been superposed.

The second joining portions 53A are respectively joined to the first joining portions 43A and together with the first joining portion 43A maintains a state where the second tubular member 52 is disposed along the first tubular member 42. The first joining portions 43A and the second joining portions 53A both have sufficient rigidity to maintain the state in which the second tubular member 52 is disposed along the first tubular member 42. By joining the second joining portions 53A to the first joining portions 43A at least part of the second tubular member 52 in the length direction X21 is routed along the first tubular member 42.

In the state where the second housing member 51 is joined to the first housing member 41, the second tubular member 52 falls within a height range A1 of the first tubular member 42 along the height direction Z11, for example. Also in this state, the first joining portions 43A and the second joining portions 53A each have a part disposed outside the height range A1 of the first tubular member 42 along the height direction Z11.

The second embodiment can achieve the following effects in addition to the effects (1-1) to (1-5) and (1-11) of the first embodiment described above.

(2-1) The first tubular member 42 has the side wall 42a at one end of the first tubular member 42 in the width direction Y11 of the first tubular member 42. The second tubular member 52 has the side wall 52b that faces and makes surface contact with the side wall 42a.

According to this configuration, when the first wire 20 that passes through the first tubular member 42 generates heat due to the passing of current, the heat of the first wire 20 is transferred to the first tubular member 42 and then transferred from the side wall 42a to the second tubular member 52. Accordingly, since the heat of the first wire 20 can also be radiated from the second tubular member 52, the ability of the routing member 40A to radiate heat can be improved.

(2-2) The first tubular member 42 has the side wall 42c at one end of the first tubular member 42 in the height direction Z11 of the first tubular member 42. The second tubular member 52 has the side wall 52c at one end of the second tubular member 52 in the height direction Z21 of the second tubular member 52. The first joining portions 43A are provided integrally with the side wall 42c. The second joining portions 53A are provided integrally with the side wall 52c. The first joining portions 43A and the second joining portions 53A are superposed in the width direction Y11 of the first tubular member 42.

According to this configuration, when joining the first joining portions 43A and the second joining portions 53A, it is sufficient to join the first joining portion 43A and the second joining portion 53A that have been superposed in the width direction Y11. Accordingly, the first joining portion 43A and the second joining portion 53A can be easily joined.

(2-3) Each of the first joining portions 43A includes a first bolt hole 44A that passes through the first joining portion 43A in the direction in which the first joining portion 43A and the second joining portion 53A overlap. Each of the second joining portions 53A includes a second bolt hole 54A that passes through the second joining portion 53A in the direction in which the first joining portion 43A and the second joining portion 53A overlap. A first bolt hole 44A and the second bolt hole 54A of a second joining portion 53A that has been superposed on the first joining portion 43A with that first bolt hole 44A are disposed side by side in the direction in which the first joining portion 43A and the second joining portion 53A overlap. According to this configuration, by using the bolts 61 that pass through the first bolt holes 44A and the second bolt holes 54A and the nuts 62 that are fitted onto the bolts 61, the first joining portions 43A and the second joining portions 53A can be joined more easily.

The above embodiments can be implemented with the following modifications. It is possible to implement the above embodiments and the modifications given below in combination with each other within a range that is technically consistent.
In the second embodiment described above, the first housing member 41A may further include at least one first joining portion 43A that is integrally provided on the side wall 42d. These first joining portions 43A protrude in the opposite direction to the height direction Z11 from an end region of the side wall 42d in the opposite direction to the height direction Z11, for example. The second housing member 51A may further include at least one second joining portion 53A that is integrally provided on the side wall 52d. These second joining portions 53A protrude in the opposite direction to the height direction Z21 from an end region of the side wall 42c in the height direction Z21, for example. With this configuration, by joining the first joining portions 43A and the second joining portions 53A that protrude in the height direction Z11 and also joining the first joining portions 43A and the second joining portions 53A that protrude in the opposite direction to the height direction Z11, it is possible to join the second housing member 51 to the first housing member 41.
In the second embodiment described above, the first joining portion 43A and the second joining portion 53A may be superposed in the length direction X11. In this case, the first bolt hole 44A passes through the first joining portion 43A in the length direction X11. The second bolt hole 54A passes through the second joining portion 53A in the length direction X21. With this configuration also, the same effect as (2-3) of the second embodiment described above can be obtained.
In the first embodiment described above, the first joining portion 43 and the second joining portion 53 may be superposed in the length direction X11. In this case, the first joining portion 43 and the second joining portion 53 are both shaped as a flat plate that is perpendicular to the length direction X11, for example. The first bolt hole 44 passes through the first joining portion 43 in the length direction X11. Likewise, the second bolt hole 54 passes through the second joining portion 53 in the length direction X21.
In the second embodiment described above, the side wall 42a and the side wall 52b do not need to be in surface contact.
In the first embodiment described above, the fastener 63 is located at an intermediate part of the side wall 42a in the height direction Z11, and is located at an intermediate part of the side wall 52b in the height direction Z21. However, the position of the fastener 63 in the height direction Z11 is not limited to the position used in the first embodiment.

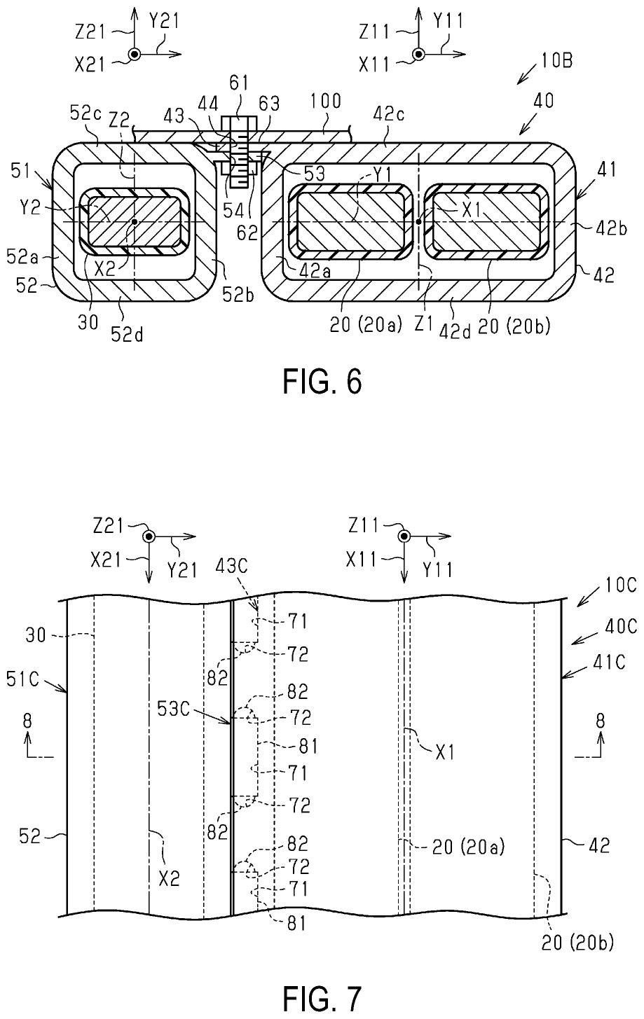

As one example, the wire harness 10B depicted in FIG. 6 includes the fastener 63. Note that configurations that are the same as or correspond to the first embodiment described above have been assigned the same reference numerals in FIG. 6. The fastener 63 differs from the first embodiment in the position of the fastener 63 in the height direction Z11. The first joining portion 43 protrudes from an end region of the side wall 42a in the height direction Z11 toward the side wall 52b along the first axis Y1. The second joining portion 53 is located at an end region of the side wall 52b in the height direction Z21.

A vehicle V includes a vehicle body panel 100. The first joining portion 43 and the second joining portion 53 are joined to the vehicle body panel 100 using the bolt 61 and the nut 62, for example. In this case, the bolt 61 may be a stud bolt, for example. The fastener 63 that joins the first joining portion 43 and the second joining portion 53 is located at an end region of the side wall 42a and at an end region of the side wall 52b in the height direction Z11.

With this configuration, attachment of the wire harness 10B to the vehicle V and the joining of the second housing member 51 to the first housing member 41 can be performed at the same time.
The first joining portion 43 may be provided on the side wall 42b or the side wall 42d. Likewise, the second joining portion 53 may also be provided on the side wall 52a or the side wall 52d.
The respective shapes of the first joining portion 43, the second joining portion 53, the first joining portion 43A, and the second joining portion 53A are not limited to plate-like shapes, and such components may have three-dimensional forms that are not plate shapes.
In the first embodiment described above, the first joining portion 43 and the second joining portion 53 do not need to be joined using the bolt 61 and the nut 62. As another example, the first joining portion 43 and the second joining portion 53 may be joined by a fixing pin. The same applies to the first joining portion 43A and the second joining portion 53A of the second embodiment.

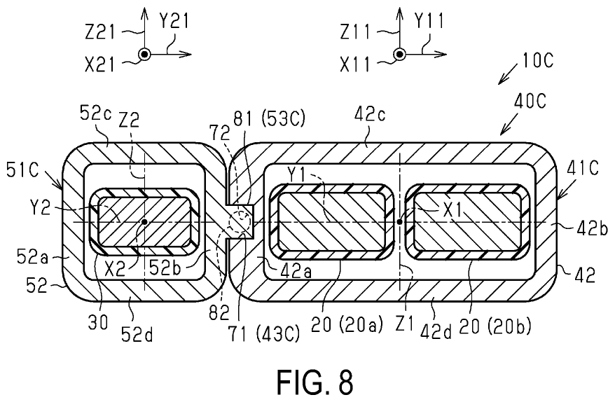

As one example, a wire harness 10C depicted in FIGS. 7 and 8 may include a routing member 40C in place of the routing member 40 according to the first embodiment. Note that in FIGS. 7 and 8, the same reference numerals have been assigned to configurations that are the same as or correspond to configurations in the first embodiment. FIG. 8 is a cross-sectional view taken along a line 8-8 in FIG. 7. The routing member 40C includes a first housing member 41C and a second housing member 51C. The first housing member 41C includes the first tubular member 42 according to the first embodiment described above and at least one first joining portion 43C provided integrally with the first tubular member 42. The second housing member 51C includes the second tubular member 52 according to the first embodiment described above and at least one second joining portion 53C provided integrally with the second tubular member 52.

The first joining portions 43C include a plurality of joining recesses 71 that are recessed in the width direction Y11 into the side wall 42a. The plurality of joining recesses 71 are aligned in the length direction X11 at certain intervals. Both end faces in the length direction X11 of a joining recess 71 have mating recesses 72 that are recessed in the length direction X11 or in the opposite direction to the length direction X11.

The second joining portions 53C include a plurality of joining protrusions 81 that are inserted into the joining recesses 71. Each of the joining recesses 71 protrudes in the height direction Z21 from the side wall 52b. The plurality of joining protrusions 81 are aligned in the length direction X21 at certain intervals. Each of the joining protrusions 81 includes mating protrusions 82 that protrude in the opposite direction to the length direction X21 or in the length direction X21 on both end faces in the length direction X21. The second joining portions 53C are joined to the first joining portions 43C by inserting the joining protrusions 81 into the joining recesses 71 while fitting the mating protrusions 82 into the mating recesses 72.
In the first embodiment described above, the first joining portions 43 and the second joining portions 53 do not need to fall within the height range A1 of the first tubular member 42 in the height direction Z11. Also, the first joining portions 43 and the second joining portions 53 do not need to fall within the height range A2 of the second tubular member 52 in the height direction Z11.
The internal space S1 of the first tubular member 42 does not need to have a sufficient width W1 that enables a plurality of first wires 20 to be disposed side by side along the width direction Y11. The internal space S1 may have a width that enables a plurality of first wires 20 to be disposed side by side along the height direction Z11, for example.
The second tubular member 52 does not have to fall within the height range A1 of the first tubular member 42 in the height direction Z11. As one example, the second tubular member 52 may have a part disposed outside the height range A1 of the first tubular member 42 in the height direction Z11.
The height of the second tubular member 52 may be higher than the height of the first tubular member 42. The width of the second tubular member 52 may be wider than the width of the first tubular member 42.
In each of the above-described embodiments, the first tubular member 42 and the second tubular member 52 are disposed side by side in the width direction Y11 and so that the height direction Z11 of the first tubular member 42 and the height direction Z21 of the second tubular member 52 are parallel. However, so long as at least a part of the second tubular member 52 in the length direction X21 is disposed along the first tubular member 42, the positional relationship between the first tubular member 42 and the second tubular member 52 is not limited to this. As one example, the first tubular member 42 and the second tubular member 52 may be disposed side by side in the height direction Z11 and so that the width direction Y11 of the first tubular member 42 and the width direction Y21 of the second tubular member 52 are parallel. As another example, the second tubular member 52 may be disposed as a position that is shifted with respect to the first tubular member 42 in the height direction Z11 and is shifted in the width direction Y11. As yet another example, the first tubular member 42 and the second tubular member 52 may be disposed so that the height direction Z11 and the height direction Z21 intersect.
The external shape of the first tubular member 42 in a horizontal section may be a rectangle with an equal width and height. The external shape of the first tubular member 42 in a horizontal section may be shaped as a polygon aside from a quadrangle, or may be a circular shape, an elliptical shape, a rounded rectangular shape, or any other freely chosen shape. In the same way, the external shape of the first tubular member 42 in a horizontal section may be shaped as a polygon aside from a quadrangle, or may be a circular shape, an elliptical shape, a rounded rectangular shape, or any other freely chosen shape.
In each of the embodiments described above, the first tubular member 42 and the second tubular member 52 do not need to be sufficiently rigid to retain their own shapes.
In the first embodiment described above, the length direction of the first tubular member 42 may be the opposite direction to the length direction X11. Alternatively, the width direction of the first tubular member 42 may be the opposite direction to the width direction Y11. The opposite direction to the height direction Z11 may be the height direction of the first tubular member 42. The length direction of the second tubular member 52 may be the opposite direction to the length direction X21. Alternatively, the width direction of the second tubular member 52 may be the opposite direction to the width direction Y21. Also, the height direction of the second tubular member 52 may be the opposite direction to the height direction Z21. The same modifications may be made to the second embodiment.
In the first embodiment described above, the wire harness 10 includes two first wires 20 and one second wire 30. However, the number of the first wires 20 included in the wire harness 10 may be one or may be three or more. A plural number of the second wires 30 may also be included in the wire harness 10. The same modifications may be made to the second embodiment.
The positional relationship between the electric device M1 and the electric device M2 in the vehicle V may be reversed.

As depicted in FIG. 1, the routing member 40 may have a bent portion that bends according to the wiring route, and may protect the wire over the entire length of the routing member 40.

The first housing member 41 (41A, 41C) may be a single member that includes the first tubular member 42 and the first joining portions 43 (43A, 43C). As one example, the first joining portions 43 (43A, 43C) that protrude from the first tubular member 42 in the radial direction (see FIG. 3), the height direction (see FIG. 5), or the width direction (see FIG. 6) may be referred to as “first tabs” or “first joining plates”.

In the same way, the second housing member 51 (51A, 51C) may be a single member that includes the second tubular member 52 and the second joining portions 53 (53A, 53C). As one example, the second joining portions 53 (53A, 53C) that protrude from the second tubular member 52 in the radial direction (see FIG. 3), the height direction (see FIG. 5), or the width direction (see FIG. 6) may be referred to as “second tabs” or “second joining plates”. The first tubular member 42 and the first joining portions 43 (43A, 43C) may be made of the same material, and the second tubular member 52 and the second joining portions 53 (53A, 53C) may be made of the same material.

The routing member 40 may be configured to be routed on the vehicle V as depicted in FIG. 1. As depicted in FIG. 6, the first joining portions 43 of the first tubular member 42 and the second joining portions 53 of the second tubular member 52 may overlap each other and/or may overlap the vehicle body panel 100, and may be joined or fastened to the vehicle V by a joining member, which may be a combination of the bolt 61 and the nut 62. According to this configuration, the task of attaching the wire harness 10B to the vehicle V can also serve as a task of joining the first housing member 41 and the second housing member 51, which makes it possible to complete the joining of the first housing member 41 and the second housing member 51 at the same time as the attachment of the wire harness 10B to the vehicle V.

As depicted in FIGS. 7 and 8, the first joining portions 43C may include a plurality of joining recesses 71 that are recessed in the width direction Y11 into the first side wall 42a, the second joining portions 53C may include a plurality of joining protrusions 81 that are inserted into the joining recesses 71, and the second joining portion 53C may be joined to the first joining portion 43C by inserting the respective joining protrusions 81 into the corresponding joining recesses 71. This configuration makes it possible to easily join the first tubular member and the second tubular member using a simple configuration, and is advantageous in suppressing an increase in the size of the first tubular member in the height direction.

As depicted in FIGS. 7 and 8, each joining recess 71 further includes mating recesses 72 that are recessed in the length direction X11 or in the opposite direction to the length direction X11 on both end surfaces in the length direction X11 of the joining recesses 71. In this case, each joining protrusion 81 may have mating protrusions 82 that protrude in the opposite direction to the length direction X21 or in the length direction X21 on both end surfaces in the length direction X21 of the joining protrusions 81. The mating of the mating recesses 72 and the mating protrusions 82 is advantageous in facilitating the task of mechanically joining the first tubular member 42 and the second tubular member 52 and advantageous in suppressing accidental separation of the first tubular member 42 and the second tubular member 52.

All features of the embodiments disclosed here are exemplary and should not be regarded as limitations on the present disclosure. The scope of the present disclosure is indicated by the range of the patent claims, not the embodiments described above, and is intended to include all changes within the meaning and scope of the patent claims and their equivalents.

1. A routing member comprising:
a first housing that includes a first tube through which a first wire passes; and
a second housing that includes a second tube that differs from the first tube, and through which a second wire, which differs from the first wire, passes, wherein:
the first housing further includes at least one first joint provided integrally with the first tube,
the second housing further includes at least one second joint provided integrally with the second tube, and
the at least one second joint is joined to the at least one first joint and together with the at least one first joint maintains a state where the second tube is disposed along the first tube.

2. The routing member according to claim 1,
wherein the first tube and the second tube are both sufficiently rigid to maintain respective shapes thereof.

3. The routing member according to claim 1, wherein:
the first tube has an external form in a horizontal section that is rectangular with a shorter height than a width,
the second tube has an external form in a horizontal section that is rectangular with a shorter height than a width or rectangular with an equal width and height, and
the first tube and the second tube are disposed side by side in a width direction of the first tube and so that a height direction of the first tube and a height direction of the second tube are parallel.

4. The routing member according to claim 3,
wherein the second tube falls within a range of a height of the first tube along the height direction of the first tube.

5. The routing member according to claim 3, wherein:
the first wire includes a plurality of first wires, and
an internal space of the first tube has a width that enables the plurality of first wires to be disposed side by side along the width direction of the first tube.

6. The routing member according to claim 3,
wherein the at least one first joint and the at least one second joint each fall within a range of a height of the first tube along the height direction of the first tube and fall within a range of a height of the second tube.

7. The routing member according to claim 6, wherein:
the first tube includes a first side wall at one end of the first tube in the width direction of the first tube,
the second tube includes a second side wall that faces the first side wall, and
each of the first joint and the second joint is positioned between the first side wall and the second side wall in the width direction of the first tube.

8. The routing member according to claim 6, wherein:
the first tube includes a first side wall at one end of the first tube in the width direction of the first tube,
the second tube includes a second side wall that faces the first side wall, and
a fastener that joins the first joint and the second joint is located at an intermediate part of the first side wall in the height direction of the first tube and is located at an intermediate part of the second side wall in the height direction of the second tube.

9. The routing member according to claim 7, wherein:
the first joint protrudes from the first side wall toward the second side wall,
the second joint protrudes from the second side wall toward the first side wall, and
the first joint and the second joint are superposed in the height direction of the first tube.

10. The routing member according to claim 9, wherein:
the at least one first joint includes a first bolt hole that passes through in the height direction of the first tube,
the at least one second joint includes a second bolt hole that passes through in the height direction of the second tube, and
each of the first bolt hole and the second bolt hole of the at least one second joint that has been superposed on the at least one first joint including the first bolt hole are aligned in the height direction of the first tube.

11. The routing member according to claim 3, wherein:
the first tube includes a first side wall at one end of the first tube in the width direction of the first tube, and
the second tube includes a second side wall that faces the first side wall and makes surface contact with the first side wall.

12. The routing member according to claim 11, wherein:
the first tube includes a first joining side wall at one end of the first tube in the height direction of the first tube,
the second tube includes a second joining side wall at one end of the second tube in the height direction of the second tube,
the at least one first joint is provided integrally with the first joining side wall,
the at least one second joint is provided integrally with the second joining side wall, and
the at least one first joint and the at least one second joint are superposed in the width direction of the first tube or in a length direction of the first tube.

13. The routing member according to claim 12, wherein
each first joint has a first bolt hole that passes through the first joint in a direction in which the first joint and the second joint overlap,
each second joint has a second bolt hole that passes through the second joint in a direction in which the first joint and the second joint overlap, and
each of the first bolt hole and the second bolt hole of a second joint superposed on a first joint including the first bolt hole are aligned in a direction in which the first joint and the second joint overlap.

14. A wire harness comprising:
the routing member according to claim 1;
at least one of the first wire that passes through the first tube; and
at least one of the second wire that passes through the second tube.
